(19) United States
(12) Patent Application Publication
(10) Pub. No.: US 2005/0066995 A1
(43) Pub. Date: Mar. 31, 2005

(54) NON-HERMETIC ENCAPSULANT REMOVAL FOR MODULE REWORK

(75) Inventors: Patrick A. Coico, Fishkill, NY (US); James H. Covell II., Poughkeepsie, NY (US); Brenda L. Peterson, Wappingers Falls, NY (US); Frank. L. Pompeo, Redding, CT (US); Deborah A. Sylvester, Poughkeepsie, NY (US); Tsong-Lin Tai, Stormville, NY (US); Jaimal M. Williamson, Wappingers Falls, NY (US); Jiali Wu, Yorktown Heights, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, ARMONK, NY (US)

(21) Appl. No.: 10/605,431

(22) Filed: Sep. 30, 2003

(51) Int. Cl. C23G 1/00; C11D 17/08

(52) U.S. Cl. 134/2; 510/407; 510/421

(57) ABSTRACT

A depolymerization cleaning solution, and method of using such solution, for removing undesirable thermoset polymer sealants residing on electronic components to provide such components with a clean seal surface for a subsequent rework process. The depolymerization cleaning solution includes a premixed metal hydroxide or amino onium salt saturated solution having a surfactant. It is particularly useful for the localized deposition and removal of thermoset polymer sealants, such as polysiloxanes, within sealband areas of the components, which have been applied on such components with different levels of chemical inertness. The material set and method disclosed in the present invention are the basis for a low cost electronic package adhesive rework process.

### BACKGROUND OF INVENTION

1. Field of the Invention

The present invention relates to semiconductor technology, and in particular, to methods for locally removing polymer thermoset non-hermetic encapsulant sealants.

2. Description of Related Art

Lids (or caps) are often attached to single or multi chip electronic packages to provide physical and environmental protection to the semiconductor devices attached thereto. These lids, which are commonly fabricated of aluminum or other thermally conductive material, may additionally serve as a heat sink or a site for heat sink attachment. In attaching the lid to the electronic package, an adhesive is typically applied to the perimeter or enclosed area designated for sealing and attachment of the lid to the electronic package. The adhesives commonly used include those that provide a low elasticity modulus for stress relief, chemical resistance, thermal stability, hydrophobicity and low cost.

Typical adhesives used to attach a lid to an electronic package include silicone-based adhesives. These types of adhesives have an inherent thermal and mechanical stability over a wide range of temperatures thereby enabling versatility amongst an array of semiconductor products. However, these silicone-based adhesives are difficult to remove or to subsequently adhere to in a rework scenario. For example, a polydimethyl siloxane polymer chain instills hydrophobicity, and as a consequence, provides reliability without hermeticity. Yet, upon curing, crosslinking transforms the material into a thermoset, and as such, the removal of this thermoset material becomes intractable due to the cured network of polymer chains. As a result, expensive high-end multi chip modules having these thermoset materials on surfaces thereof are often not recoverable.

In the fabrication of integrated circuits, and their workable lifetime, the issue of electronic package lid rework arises at multiple points. Lid and module rework are often performed on higher-end, more expensive modules, as it is a common remedy for misplaced or misoriented, leaking, mismarked, or incorrect lids in the encapsulation step of production, as well as electrical test failure of one chip or device in a multi chip package. Lid and module rework are also common in high-value packages, such as those returned from field service, and for the reclamation of high cost lids and modules.

Yet, a major problem of lid and module rework, particularly in those lids attached by or having residual polymer adhesive thereon, is that these adhesives are difficult to remove, as well as being difficult to adhere to in a subsequent rework scenario without damaging the lid itself or even the resultant electronic package. Silicone-based adhesives are one such class of polymer systems that are often difficult to remove from these high-end, high-value electronic package components.

Therefore, a need exists in the art for providing improved methods and compositions for the removal of polymer systems, particularly silicone-based adhesives, from electronic components for their subsequent use and re-use in integrated circuit fabrication processing.

### SUMMARY OF INVENTION

Bearing in mind the problems and deficiencies of the prior art, it is therefore an object of the present invention to provide an improved cleaning solution and method of using such cleaning solution for the removal of thermoset polymers from electronic modules.

Another object of the present invention is to provide a cost effective method having reduced processing steps to remove thermoset polymers from electronic components.

It is another object of the present invention to provide a cost effective method to reuse the expensive high-end, multi-chip modules after module rework.

A further object of the invention is to provide a cost effective method to reuse high-end lids attached to modules via the thermoset polymer after module rework.

It is yet another object of the present invention to provide a manufacturable method that enables a cost effective and time efficient module rework process.

Still other objects and advantages of the invention will in part be obvious and will in part be apparent from the specification.

The above and other objects and advantages, which will be apparent to one of skill in the art, are achieved in the present invention, which is directed to in a first aspect a method to locally remove polymer sealant from a semiconductor device. The method includes providing at least one component having a thermoset polymer sealant on a surface thereof such as, for example within a sealband area of the component surface. The component may include a substrate, base plate, metal cap, ceramic chip carrier, organic chip carrier or a heat sink.

Once the thermoset polymer sealant is detected, a depolymerization cleaning solution is applied to the thermoset polymer sealant. This depolymerization cleaning solution comprises a salt saturated solvent having surfactant. In so doing, the thermoset polymer sealant is contacted with the depolymerization cleaning solution such that the solution chemically degrades the polymer sealant for the removal thereof. Once degraded, the thermoset polymer sealant is removed from the surface of the component.

The method may further include providing a confinement means on the surface of the component to isolate the sealband area from any electrically active features on the surface. This confinement means protects and avoids contact of these electrically active features with the applied depolymerization cleaning solution. Preferably any bulk polymer is initially removed so as to leave residual polymer sealant. In removing this residual sealant, the component is heated to a temperature that is at least under the boiling point of the organic solvent in solution prior to locally applying the depolymerization cleaning solution substantially only to the area of the residual thermoset polymer sealant.

Once the depolymerization cleaning solution is applied to the thermoset polymer sealant, it is allowed to remain on the surface for a sufficient time adequately depolymerizing the polymer sealant. It is then rinsed off the component and the component dried to provide a clean sealing surface for a subsequent rework process.

In the invention, the depolymerization cleaning solution comprises a soluble salt such as KOH, alkali acetate (CH₃CO₂Na, CH₃CO₂K), alkali propionate (CH₂H₅CO₂Na), akali amide (NaNH₂), sodium acrylate (H₂C═CHCO₂Na), NaF, KF, LiF, Na2Si₃O₇, sodium hydrosulfite (Na₂S₂O₄), monoesters and/or diesters of phosphoric acid of the general formula: O═P(OH)ₙ(OR)₃₋ₙ, n is 1, 2 or 3, Na₂HPO₄, NaSO₃R (R=C₁-C₆-alkyl or phenyl), Na₂HPO₄, K₂HPO₄, TBAF, TEAH, TBAH, TMAH, TMAF, TPAF, TEAB, TBAI, tetrabutylammonium tetrafluoroborate (TBA-TFB), NH₂NH₂, NH₂OH, N(CH₂CH₃)₃ or combinations thereof. The solvent of the solution may include water, methanol, ethanol, propanol, isopropanol, tert-butyl alcohol, dimethyl sulfoxide (DMSO), acetonitrile, dimethylformamide (DMF), nitromethane, hexamethyl phosphoramide (HMPA), acetone, cyclohexanone, pyridine or combinations thereof. The surfactant may includes fluorosurfactant (1,4-dioxane), nonionic surfactant (alcohol ethoxylate), poly (ethylene glycol monooleate), an organic surfactant or combinations thereof.

In a second aspect, the invention is directed to a method for reworking an electronic module. This aspect includes providing an electronic module having a first component attached to a second component via a sealband area of thermoset polymer sealant. These components are detached from each other such that portions of the thermoset polymer sealant remain on at least one of the components. A depolymerization cleaning solution is applied to the sealband area having remaining thermoset polymer sealant, such as, residual polymer sealant after any bulk sealant is removed. This cleaning solution comprises a salt saturated solvent having surfactant. Once the cleaning solution contacts the remaining thermoset polymer sealant, it degrades such thermoset polymer sealant for removal thereof. This degraded polymer sealant is then removed from the surface of the component to provide a clean surface the component for a subsequent rework process.

This aspect of the invention may further include a confinement means on the surface of the component having polymer thereon. In so doing, the confinement means to isolate the sealband area from any electrically active features on the surface, therein the confinement means protecting and avoiding contact of the electrically active features with the applied depolymerization cleaning solution.

In a third aspect, the invention is directed to a depolymerizing cleaning composition. The composition comprises a premixed metal hydroxide or amino onium salt saturated organic solvent having a surfactant for chemical degradation of thermoset polymer systems, where all such constituents form a blend in solution.

In this aspect, the salt is present in an amount ranging from about 1.0 wt % to about 50.0 wt % of the cleaning solution for generating nucleophiles via dissociation in the solvent, while the surfactant is present in an amount ranging from about 0.1 wt % to about 5.0 wt % of the cleaning solution for accelerating surface wetting and preventing corrosion. Optionally, the cleaning composition may also include an organic acid in an amount ranging from about 0.1 wt % to about 3.0 wt % of the solution for increasing chemical activity, as well as filler in an amount ranging from about 5.0 wt % to about 20.0 wt % of the cleaning solution to obtain a desired viscosity of such solution.

### BRIEF DESCRIPTION OF DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 illustrates an electronic module for use in accordance with the invention comprising first and second components attached via a thermoset polymer sealant.

FIG. 2 illustrates the present step of detaching the components of FIG. 1 such that bulk thermoset polymer sealant may remain on the first and/or second detached components.

FIG. 3 illustrates the present step of removing bulk thermoset polymer sealant from the components of FIG. 2 such that residual polymer sealant remains on the components.

FIG. 4 illustrates the present step of removing residual thermoset polymer sealant residing within the sealband area of the components of FIG. 3 using the depolymerizing cleaning solution of the invention.

### DETAILED DESCRIPTION

In describing the preferred embodiment of the present invention, reference will be made herein to FIGS. 1-4 of the drawings in which like numerals refer to like features of the invention. Features of the invention are not necessarily shown to scale in the drawings.

The material set and method disclosed herein are the bases for a low cost electronic package adhesive rework process including appropriate hardware and equipment alternative. An advantage of the foregoing lid rework method and material set is that it can be implemented on many levels of scale at minimal cost, with minimal effort and ease of flexibility, as well as across a variety of differing types and material sets of electronic packages.

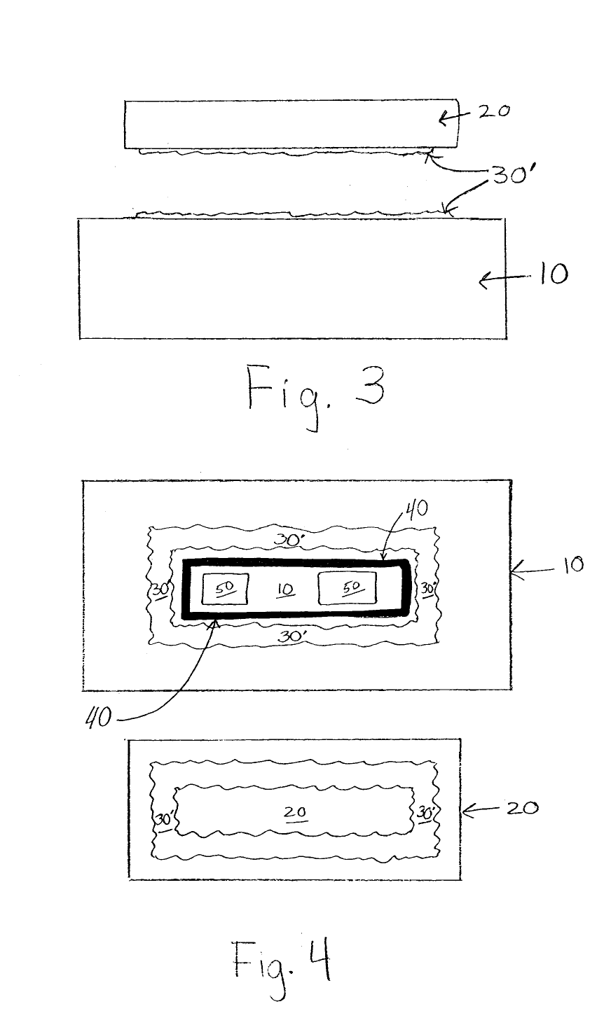

In so doing, the present invention discloses a chemical cleaning solution for the removal of undesirable polymer sealants residing on electronic components. This chemical cleaning solution comprises a premixed metal hydroxide or amino onium salt saturated organic solution for the depolymerization of polymer systems, such as polysiloxanes (i.e. silicones), which have been applied on the substrates with different levels of chemical inertness, and the corresponding cleaning processes. The area of interest on the chip carrier is a perimeter seal band of polymer on a substrate (as shown in FIG. 4) whereby the depolymerization solution in solvent is applied locally to this area for removal of the polymer systems, such as a silicone-based adhesive. The invention provides for an effective, efficient removal approach to chemically degrade the polymer systems as a rework “spot”process, i.e., a localized removal process, without the use of dedicated fixtures, tools, facility infrastructure and/or instrumentation, therein providing a low cost material set and method of reworking lids and modules.

The invention will be better understood in accordance with the description below of the critical steps of chemical solution preparation followed by localized polymer sealant removal.

A module processed in accordance with the invention comprises a first component 10 attached to a second component 20 by a polymer sealant 30. The first and second components may comprise any known structures or components used in the fabrication of integrated circuits including, but not limited to, a substrate, base plate, metal cap, ceramic chip carrier, organic chip carrier, heat sink, and the like.

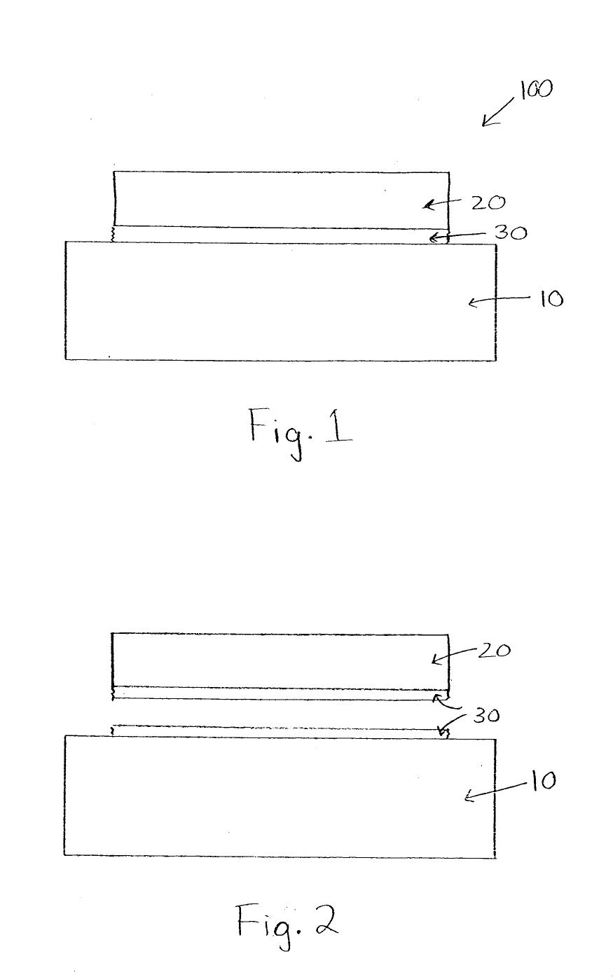

For ease of understanding, the invention will be described with reference to module 100 comprising a substrate 10 attached to a metal cap 20 via polymer sealant 30 as shown in FIG. 1. The substrate 10 and metal cap 20 may be detached from each other by known techniques, whereby bulk polymer sealant 30 typically remains on the substrate, the metal cap, or even both as shown in FIG. 2.

This bulk polymer sealant 30 remaining on surfaces of the detached components is then initially removed therefrom by either manual techniques or using known removal apparatus. In a preferred embodiment, any bulk polymer sealant 30 remaining on surfaces of the first and/or second components is removed by manually shaving or shearing the sealant off such surfaces using known apparatus, such as, a spatula or a razor blade. Wherein these first and second components comprise a ceramic substrate 10 and a metal cap 20, respectively, the bulk polymer sealant 30 is removed using a plastic spatula or Cu spatula, which, is particularly useful in removing any polymer sealant that may reside within deep trenches on the metal cap. Alternatively, the bulk sealant may be removed by a known blasting technique. In so doing, the blasting process may be aided by the use of confinement means 40 surrounding any electrically active features on the components 10, 20. The confinement means 40 advantageously protect these electrically active features during the blasting process.

Once any bulk polymer sealant is removed from the first and second components, preferably from substrate 10 and metal cap 20, a film of silicone or polymer sealant, may remain or be detected in those areas where bulk polymer was removed. The excess silicone may be detected either visually or using known imaging equipment. Any excess silicone or polymer sealant having been detected is then removed by the method disclosed herein.

Referring to FIG. 3, after any bulk polymer sealant is removed, and optionally any excess silicone thereof removed, a thin residual film of polymer sealant 30′ may remain on the first component, the second component or both. This residual film of polymer sealant 30′ may be detected either visually or using known imaging equipment.

In accordance with the invention, once any residual film of polymer sealant 30′ is detected, the present invention provides an improved and efficient process of removing such residual film by chemically degrading this residual film of polymer sealant 30′ while substantially avoiding chemical contamination and induced chemical and electrochemical corrosion of both top-side metallurgy (TSM) and back-side metallurgy (BSM), as well as at the metal micro-vias buried in ceramic chip carrier. An essential feature of the invention, is that the present process locally and/or site-specifically removes any detected residual film of polymer sealant 30″ on the surfaces of the components, i.e., substrate 10 and metal cap 20.

The components 10, 20 having the residual film of polymer sealant 30′ on surfaces thereof are initially heated and maintained at a temperature ranging from about 25° C. to about 70° C., preferably to about 60° C. This may be accomplished using any known heating equipment, such as, a hot plate, an oven, and the like. Preferably, substrate 10 and metal cap 20 are heated using a hot plate, and maintained at a temperature ranging from about 45° C. to about 50° C., preferably to about 50° C.

Once the components 10, 20 are heated and maintained at a desired temperature, the premixed metal hydroxide or amino onium salt saturated organic solution of the invention for the depolymerization of the residual film of polymer sealant 30′ is locally dispensed directly onto the surfaces of the components preferably substantially only within the locations or areas where residual film 30′ resides. The depolymerization solution of the invention is deposited in an amount sufficient so as to completely cover the residual polymer sealant 30′.

The deposition of the depolymerization solution may be accomplished with the aid of confinement means 40, as schematically depicted in the top plan view of FIG. 4. A variety of differing confinement means, as known and used in the art, may be used in accordance with the invention such as, but not limited to, a shield, a barrier, o-ring, metal cap, and the like. Preferably, the confinement means 40 sufficiently blocks or barricades the electronically active components 50 of the electronic module such as, but not limited to, a chip, chip package, and the like, from those regions of components 10, 20 having residual film 30′ thereon, as shown in FIG. 4. These confinement means 40 advantageously assist in the confinement and localization of step of depositing the depolymerization solution of the invention to essentially only those locations where residual film 30′ resides on the components 10, 20.

In this manner, the deposited depolymerization solution of the invention is locally confined to completely cover those areas where residual film 30′ resides on the surfaces of components 10, 20, while protecting and preventing regions of components 10, 20 not having residual polymer sealant 30′ thereon from being exposed to the deposited depolymerization solution. This confinement means 40 also advantageously decreases vaporization of the deposited premixed Lewis alkali solution to ensure that the depolymerization solution remains within the region of residual polymer sealant so as to entirely cover such sealant throughout the process of removal thereof.

In all aspects of the invention, the depolymerization solution is a premixed metal hydroxide or amino onium salt saturated organic solution that at least includes a soluble salt, a solvent and a surfactant. However, as is discussed further below, the compositions of the salts, solvents and surfactants of the depolymerization solution, and the combinations thereof, vary depending upon the material composition of components 10, 20 to be locally cleaned of any residual polymer sealant 30′ using such depolymerization solution. Preferably, the depolymerization solution comprises a Lewis alkali chemical solution.

In a first embodiment, for the removal of residual film of polymer sealant 30′ from components with substantially high chemical stability such as, but not limited to, Pyrex, ceramic, chrome or aluminum anodized finished surface, and the like. Typically, such components are attached to each other using a substantially flexible adhesive, such as, any silicone-based adhesive, i.e., a polysiloxane. The depolymerization solution of the invention for removal of film residue of such silicone-based adhesives advantageously provides sufficient activity and efficiency for the removal of these silicone-based adhesives. Again, the depolymerization solution at least includes a soluble salt, solvent and surfactant.

In this first embodiment, the suitable soluble salts include those that generate nucleophiles via dissociation in the solvent component of the solution. Preferably, the suitable soluble salts for use in this first embodiment include reagents having relatively small dimensions, low electronegativity and high polarizability. For example, such suitable soluble salts may include, but are not limited to, KOH, alkali acetate (CH₃CO₂Na, CH₃CO₂K), alkali propionate (CH₂H₅CO₂Na), akali amide (NaNH₂), sodium acrylate (H₂C═CHCO₂Na), NaF, KF, LiF, Na2Si₃O₇, sodium hydrosulfite (Na₂S₂O₄), monoesters and/or diesters of phosphoric acid of the general formula: O═P(OH)ₙ(OR)₃₋ₙ, n is 1, 2 or 3, Na₂HPO₄, NaSO₃R (R=C₁-C₆-alkyl or phenyl), Na₂HPO₄, K₂HPO₄, TBAF, TEAH, TBAH, TMAH, TMAF, TPAF, TEAB, TBAI, tetrabutylammonium tetrafluoroborate (TBA-TFB), NH₂NH₂, NH₂OH, N (CH₂CH₃)₃ and the like. The soluble salts may be added to the solvent component in an amount ranging from about 1.0 wt % to about 50.0 wt %.

The solvent component of the depolymerization solution of the first embodiment has the ability of acting as both a salt dissociation media, of the above listed soluble salts, as well as an accelerator for the solvation of depolymerizabon of the silicone-based adhesives. Solvents having a sufficient dielectric constant, such as those have a dielectric constant ranging from about 10 to about 80. The solvents for use in the first embodiment may include, but are not limited to, water, methanol, ethanol, propanol, isopropanol, tert-butyl alcohol, dimethyl sulfoxide (DMSO), acetonibile, dimethylformamide (DMF), nitromethane, hexamethyl phosphoramide (HMPA), acetone, cyclohexanone, pyridine and combinations thereof.

The surfactant component of this embodiment of the depolymerizabon solution advantageously accelerates surface wetting and prevents metal corrosion. Suitable surfactants for use in the first embodiment include, but are not limited to, fluorosurfactant (1,4-dioxane), nonionic surfactant (alcohol ethoxylate), poly (ethylene glycol monooleate) and the like. Organic surfactants may be added to the solution for the removal of low polar polymers such as, for example, polyoxyalkylene block copolymers and the like. The surfactant may be added to solution in an amount ranging from about 0.1 wt % to about 5.0 wt %. Thus, the concentration of the invented formula could be from 10 wt % to the saturate, i.e., 50 wt %.

In a second embodiment, the invention discloses a depolymerization solution for the removal of residual film of polymer sealant 30′, particularly a silicone-based adhesive, from components with substantially less chemical stability in comparison to the materials of the components of the first embodiment. The components of the second embodiment may include, but are not limited to, an organic module such as an organic carrier, a metal cap, and the like. These types of components with less chemical stability are more susceptible to damage. In this embodiment, the depolymerization solution also includes at least a soluble salt, solvent and surfactant.

The soluble salt of the solution of the second embodiment are those that generate nucleophiles via dissociation in solvent, such as those listed above with reference to the first embodiment. In addition, the solvent of the second embodiment also includes mixtures of aliphatic, naphthenic and aromatic hydrocarbons such as, but not limited to, crystal oil k 60, isoeicosane or oligomer polysiloxanes of the general formula R₃Si—[O—Si(R₂)—]ₓO—SiR₃, in which R=C1-C6 alkyl, phenyl, wherein the radicals within the molecule can be identical or different and X=0; 20, preferably 0 to 10. In this second embodiment, these mixtures of aliphatic, naphthenic and aromatic hydrocarbons may partially or completely replace the solvent medias of the depolymerization solution in accordance with the first embodiment of the invention. The solvent component also acts as a salt dissociation media in addition to an accelerator for the solvation of depolymerization of the silicone-based adhesives.

The surfactant component of the depolymerization solution of the second embodiment also accelerates surface wefting and prevents metal corrosion. Suitable surfactants for use in the second embodiment also include, but are not limited to, fluorosurfactant (1,4-dioxane), nonionic surfactant (alcohol ethoxylate), poly (ethylene glycol monooleate) and the like. In addition to the surfactant, a relatively small amount of organic acid may be added to the depolymerization solution to increase the chemical activity of the solution. This organic acid may be added to the solution in an amount ranging from about 0.1 wt % to about 3.0 wt %. Furthermore, to obtain a solution with a desired viscosity, silica filler or fume silica can be added to the solution in an amount ranging from about 5 wt % to about 20 wt %.

In all embodiments, the depolymerization solutions of the invention are particularly useful for the removal of silicone-based layers from components used in the fabrication of integrated circuits. While linear polysiloxanes, such as alpha.,.mega.-dihydroxy-polydimethylsiloxanes, dimethylvinylsiloxy- or trimethylsiloxy-terminated polydimethylsiloxanes, are relatively easy to depolymerize, it has been found that crosslinked polysiloxanes, i.e., silicones, are not easily polymerized. The crosslinking of such polysiloxanes, either by addition or condensation polymerization, greatly impair the process efficiency of removal of such silicones. Furthermore, thicker silicone residues conventionally require more processing time for removal thereof, as well as polymer-based encapsulants being difficult to remove from high-end single and/or multi chip modules due to the intractable nature of such type of encapsulants, which leads to a tremendous waste of this costly hardware, especially in the high-end MCM area.

Advantageously, the foregoing techniques and depolymerization solutions of the invention make it easier and more efficient and reliable to remove these thermoset polymer residues, whether the residues by thick or thin, or of a linear or crosslinked nature. In addition, the present invention is particularly useful for the removal of silicone-based layers and residues from components wherein such silicone-based layers and residues contain inorganic fillers and/or crosslinked silicone rubber domains, as well as those that are either hydrophobic or hydrophilic.

To ensure that all residual polymer sealant 30′ is removed from the surfaces of the components, a cleaning tool may be applied across the location of the residual polymer so as to loosen any bonds and break such bonds between the loosely adhered polymer sealant residue and the component. For example, this may be accomplished by gently applying a spatula, a brush, a rigid plastic brush, a razor blade, and the like, across the surface area of the components in the location of the residual polymer sealant in order to break any bonds, as well as enhance chemical degradation between the premixed solution and the residual polymer sealant 30′.

In continuing the process of the invention, once the exact locations of any residual film of polymer sealant 30′ are located on components 10, 20 of known material composition, and optionally confinement means 40 placed around any electrically active or critical components of the module so as to isolate these components from the exact location of the residual film of polymer sealant 30′, i.e., the sealband area, the depolymerization solution is either locally applied to the sealband area, or alternatively, the entire component may be completely immersed within a heated bath containing depolymerization solution. This bath may further include a mechanical agitator to increase the rate of removal of the residual film of polymer sealant 30′ from the immersed components 10, 20 by continually refreshing the surface area to which solution makes contact during the foregoing residue polymer removal process.

In the preferred embodiment, the exact locations of the residual film of polymer sealant 30′ on components 10, 20 is localized via confinement means 40 to define the sealband area, and then the depolymerization solution is deposited substantially only within this sealband area to completely cover the residual film in need of removal. In accordance with the invention, the selection of the composition of the present depolymerization solution is completely dependent upon the chemical stability of the material compositions of components 10, 20, the chemical reactivity of the adopted solution as well as the required processing time and temperature. Localized chemical treatment is preferred in comparison to complete immersion methods as it provides significantly greater amounts of polymer sealant removal as only the exact locations of such polymer sealant are treated, as well as avoids subjecting regions of components 10, 20 not having polymer sealant to unnecessary chemical processing.

A critical feature of the invention is that prior to depositing or applying the present depolymerization solution to the residual film of polymer sealant 30′, the solution is heated and maintained at a temperature that is at least under the boiling point of the solvent in solution. Preferably, the depolymerization solution is heated and maintained at a temperature ranging from about room temperature, i.e., 20-25° C. to about 50° C., preferably from about 45° C. to about 50° C. Increasing the processing temperature accelerates the depolymerization of such polymer sealants, however, it is essential that the maximum temperature be lower than the boiling temperature of the adopted solvent.

Once the premixed solution of the invention is locally deposited in the sealband area, the solution remains on the surface of components 10, 20 over the residual sealant for a time sufficient to allow degradation and dissolving of the residual polymer sealant 30′ within the premixed solution, or at least partial dissolving of the residual polymer sealant 30′, therein breaking the bond between residual polymer sealant 30′ and the component that it resides on. Preferably, the premixed solution remains over the polymer sealant for a time ranging from about 5 minutes to about 25 minutes, more preferably from about 15 minutes to about 25 minutes.

Any remaining premixed depolymerization solution, as well as any of a mixture of depolymerization solution with dissolved residual polymer sealant 30′, is washed off the surfaces of components 10, 20. This may be accomplished by a deionized water rinse or an alcohol rinse for a sufficient duration to remove all chemicals from the surfaces of the components 10, 20, such as, rinsing the components for a time ranging from about 2 minutes to about 5 minutes.

The washed components 10, 20 are then dried to remove any remaining rinse solution or material on the surfaces of the components. This may be accomplished by initially using a compressed air drying technique or a spin dry technique followed by heat and/or vacuum drying the components. The heat drying eliminates any residual rinse solution and/or moisture from the components to ensure that these components are completely dry for subsequent integrated circuit processing steps. For example, the air dried components may be provided within a vacuum oven at a pressure ranging from about 50 cm Hg to about 75 cm Hg, preferably 75 cm Hg, and vacuum baked at a temperature ranging from about 90° C. to about 150° C., preferably 120° C., for a duration ranging from about 0.5 hour to about 2 hours, preferably from about 1 hour to about 2 hours.

Once completely dried, the clean sealing surfaces of components 10, 20 are then suitable for rework and/or further integrated circuit processing. The invention advantageously provides an improved technique for the efficient, swift localized removal of polymer systems, as well as a unique solution for the chemical degradation of such polymer systems that significantly avoids any chemical contamination and/or corrosion to TSM, BSM and metal micro-vias buried in ceramic chip carrier. This method lends itself well to low cost and volume implementation as it easily and effectively removes polymer-based encapsulants from high-end single chip modules and multichip chip modules.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A method to locally remove polymer sealant from a semiconductor device comprising:
providing at least a first component having a thermoset polymer sealant on a surface thereof;
detecting said thermoset polymer sealant on said portion of said surface;
applying a depolymerization cleaning solution to said detected thermoset polymer sealant, said depolymerization cleaning solution comprising a salt saturated solvent having surfactant;
contacting said thermoset polymer sealant with said depolymerization cleaning solution such that said solution chemically degrades said thermoset polymer sealant for the removal thereof; and
removing said degraded thermoset polymer sealant from said surface of said at least first component.

2. The method of claim 1 wherein said at least first component comprises a structure selected from the group consisting of a substrate, a base plate, a metal cap, a ceramic chip carrier, an organic chip carrier and a heat sink.

3. The method of claim 1 wherein said thermoset polymer sealant is within a sealband area on said first component surface.

4. The method of claim 3 wherein said thermoset polymer sealant is within said sealband area on said first component surface, the method further including:
providing a confinement means on said surface of said at least first component to isolate said sealband area from any electrically active features on said surface, therein said confinement means protecting and avoiding contact of said electrically active features with said applied depolymerization cleaning solution.

5. The method of claim 1 wherein said steps of detecting said thermoset polymer sealant and applying said depolymerization cleaning solution comprises:
detecting said thermoset polymer sealant on said portion of said surface, said detected thermoset polymer sealant comprising bulk thermoset polymer sealant;
removing a substantial portion of said bulk thermoset polymer sealant such that residual thermoset polymer sealant remains on said portion of said surface;
heating said at least first component having said residual thermoset polymer sealant to a temperature under the boiling point of the solvent said solution; and
locally applying said depolymerization cleaning solution substantially only to said residual thermoset polymer sealant in an amount sufficient to at least cover said residual thermoset polymer sealant.

6. The method of claim 5 wherein said temperature ranges from about 25° C. to about 70° C.

7. The method of claim 5 further including the steps:
allowing said depolymerization cleaning solution to remain on said surface for a sufficient time to allow said depolymerization cleaning solution to depolymerize said residual thermoset polymer sealant;
rinsing at least said depolymerized residual thermoset polymer sealant off said surface of said at least first component; and
drying said rinsed at least first component to provide a clean sealing surface of said at least first component for a subsequent rework process.

8. The method of claim 7 wherein said sufficient time ranges from about 5 minutes to about 25 minutes.

9. The method of claim 7 wherein said step of drying said rinsed first component comprises:
pre-drying said rinsed at least first component; and
completely drying said pre-dried at least first component to remove any remaining moisture on said surface of said at least first component.

10. The method of claim 1 wherein said thermoset polymer sealant comprises a silicone-based adhesive.

11. The method of claim 1 wherein said depolymerization cleaning solution comprises a metal hydroxide or amino onium soluble salt in a solvent having surfactant, where all constituents form a blend in solution.

12. The method of claim 11 wherein said depolymerization cleaning solution comprises:
said soluble salt selected from the group consisting of KOH, alkali acetate (CH₃CO₂Na, CH₃CO₂K), alkali propionate (CH₂H₅CO₂Na), akali amide (NaNH₂), sodium acrylate (H₂C═CHCO₂Na), NaF, KF, LiF, Na₂Si₃O₇, sodium hydrosulfite (Na₂S₂O₄), monoesters and/or diesters of phosphoric acid of the general formula: O═P(OH)ₙ(OR)₃₋ₙ, n is 1, 2 or 3, Na₂HPO₄, NaSO₃R (R=C₁-C₆-alkyl or phenyl), Na₂HPO₄, K₂ HPO₄, TBAF, TEAH, TBAH, TMAH, TMAF, TPAF, TEAB, TBAI, tetrabutylammonium tetrafluoroborate (TBA-TFB), NH₂NH₂, NH₂OH, N(CH₂CH₃)₃ and combinations thereof;
said solvent selected from the group consisting of water, methanol, ethanol, propanol, isopropanol, tert-butyl alcohol, dimethyl sulfoxide (DMSO), acetonitrile, dimethylformamide (DMF), nitromethane, hexamethyl phosphoramide (HMPA), acetone, cyclohexanone, pyridine and combinations thereof; and
said surfactant selected from the group consisting of fluorosurfactant (1,4-dioxane), nonionic surfactant (alcohol ethoxylate), poly (ethylene glycol monooleate), an organic surfactant and combinations thereof.

13. The method of claim 12 wherein said soluble salts are further selected from the group consisting of aliphatic hydrocarbons, naphthenic hydrocarbons, aromatic hydrocarbons and combinations thereof.

14. The method of claim 11 wherein said metal hydroxide or amino onium salt is present in an amount ranging from about 1.0 wt % to about 50.0 wt % of said cleaning solution for generating nucleophiles via dissociation in said solvent, and said surfactant is present in an amount ranging from about 0.1 wt % to about 5.0 wt % of said cleaning solution for accelerating surface wetting and preventing corrosion.

15. A method for reworking an electronic module comprising:
providing an electronic module having a first component attached to a second component via a sealband area of thermoset polymer sealant;
detaching said first and second components from each other such that portions of said thermoset polymer sealant remain on at least one of said first and second components;
locally applying a depolymerization cleaning solution to said sealband area having remaining thermoset polymer sealant, said depolymerization cleaning solution comprising a salt saturated solvent having surfactant;
contacting said remaining thermoset polymer sealant with said depolymerization cleaning solution such that said solution chemically degrades said thermoset polymer sealant within said sealband area for the removal thereof; and
removing said degraded thermoset polymer sealant from said surface of said at least one of said first and second components to provide a clean sealing surface of said at least one of said first and second components for a subsequent rework process.

16. The method of claim 15 wherein said remaining portions of said polymer sealant comprises bulk polymer sealant, and the method further including removing substantially all of said bulk polymer sealant therein leaving residual polymer sealant within said sealband area on said surface.

17. The method of claim 15 further including the step of providing a confinement means on said surface of at least one of said first and second components to isolate said sealband area from any electrically active features on said surface, therein said confinement means protecting and avoiding contact of said electrically active features with said applied depolymerization cleaning solution.

18. The method of claim 15 further including the step of heating said at least one of said first and second components to a temperature under the boiling point of the solvent said solution prior to locally applying said depolymerization cleaning solution to said remaining thermoset polymer sealant within said sealband area.

19. The method of claim 15 further including the step of drying said clean sealing surface of said at least one of said first and second components for said subsequent rework process.

20. A depolymerizing cleaning composition comprising a premixed salt saturated solvent having a surfactant for chemical degradation of thermoset polymer systems, said salt being selected from the group consisting of a metal hydroxide salt and an amino onium salt, wherein all constituents form a blend in solution.

21. The composition of claim 20 wherein said salt is further selected from the group consisting of KOH, alkali acetate (CH₃CO₂Na, CH₃CO₂K), alkali propionate (CH₂H₅CO₂Na), akali amide (NaNH₂), sodium acrylate (H₂C═CHCO₂Na), NaF, KF, LiF, Na₂Si₃O₇, sodium hydrosulfite (Na₂S₂O₄), monoesters and/or diesters of phosphoric acid of the general formula: O═P(OH)ₙ(OR)₃₋ₙ, n is 1, 2 or 3, Na₂HPO₄, NaSO₃R (R=C₁-C₆-alkyl or phenyl), Na₂HPO₄, K₂HPO₄, TBAF, TEAH, TBAH, TMAH, TMAF, TPAF, TEAB, TBAI, tetrabutylammonium tetrafluoroborate (TBA-TFB), NH₂NH₂, NH₂OH, N(CH₂CH₃)₃ and combinations thereof.

22. The composition of claim 20 wherein said salt is further selected from the group consisting of aliphatic hydrocarbons, naphthenic hydrocarbons, aromatic hydrocarbons and combinations thereof.

23. The composition of claim 21 wherein said solvent is selected from the group consisting of water, methanol, ethanol, propanol, isopropanol, tert-butyl alcohol, dimethyl sulfoxide (DMSO), acetonitrile, dimethylformamide (DMF), nitromethane, hexamethyl phosphoramide (HMPA), acetone, cyclohexanone, pyridine and combinations thereof.

24. The composition of claim 22 wherein said surfactant is selected from the group consisting of fluorosurfactant (1,4-dioxane), nonionic surfactant (alcohol ethoxylate), poly (ethylene glycol monooleate), an organic surfactant and combinations thereof.

25. The composition of claim 20 wherein said salt is present in an amount ranging from about 1.0 wt % to about 50.0 wt % of said cleaning solution for generating nucleophiles via dissociation in said solvent, and said surfactant is present in an amount ranging from about 0.1 wt % to about 5.0 wt % of said cleaning solution for accelerating surface wetting and preventing corrosion.

26. The composition of claim 20 further including an organic acid present in an amount ranging from about 0.1 wt % to about 3.0 wt % of said cleaning solution for increasing the chemical activity of said solution.

27. The composition of claim 26 further including a filler present in an amount ranging from about 5.0 wt % to about 20.0 wt % of said cleaning solution to obtain a desired viscosity of said solution.
